(19) United States
(12) Patent Application Publication
(10) Pub. No.: US 2026/0367562 A1
(43) Pub. Date: Nov. 19, 2026

(54) IMAGE FORMING APPARATUS

(71) Applicant: CANON KABUSHIKI KAISHA, Tokyo (JP)

(72) Inventor: KO HIRAI, Ibaraki (JP)

(21) Appl. No.: 19/653,328

(22) Filed: Apr. 21, 2026

(30) Foreign Application Priority Data
May 13, 2025 (JP) 2025-080454

(51) Int. Cl. G03G 15/00; G03G 21/16

(52) U.S. Cl. CPC G03G 15/5075; G03G 15/80; G03G 21/1619; G03G 21/1647

(57) ABSTRACT

An image forming apparatus configured to form an image on a recording material includes a wireless communication board configured to receive a signal via wireless communication; a first support member configured to support the wireless communication board, a second support member configured to support the wireless communication board, the second support member having an electrical conductivity higher than an electrical conductivity of the first support member, a signal processing board configured to process the signal received by the wireless communication board, an accommodating member configured to accommodate the signal processing board, and a frame member made of metal and configured to constitute part of a casing of the image forming apparatus. The first support member is configured to be supported by the accommodating member and the second support member is configured to be supported by the frame member.

### BACKGROUND

### Field of the Technology

The present disclosure relates to an image forming apparatuses such as a printer, a copying machine, a facsimile, or a multifunction printer.

### Description of the Related Art

A recent image forming apparatus is equipped with a wireless communication board for receiving signals, such as image data, related to image formation, from an external apparatus such as a personal computer or a portable terminal. Japanese Patent Application Publication No. 2020-42188 describes a configuration for grounding a wireless communication board. In this configuration, the wireless communication board and a ground plate made of metal are disposed in a wireless-communication-board holder of a wireless LAN unit, and the wireless LAN unit is attached to a main-control-board case made of metal. Japanese Patent Application Publication No. 2019-14215 describes another configuration for grounding a wireless communication board. In this configuration, the wireless communication board (wireless LAN board) is attached to studs made of metal and disposed so as to be surrounded by a shield member.

### SUMMARY

However, in the configurations described in Japanese Patent Application Publication Nos. 2020-42188 and 2019-14215, since dedicated components, such as the ground plate and the studs, are required, as described above, for attaching the wireless communication board while ensuring the ground, the number of components increases. For this reason, it is desired to achieve a configuration that reduces the cost of the wireless communication board attached to the apparatus.

According to a first aspect of the present disclosure, an image forming apparatus configured to form an image on a recording material includes a wireless communication board configured to receive a signal via wireless communication; a first support member configured to support the wireless communication board, a second support member configured to support the wireless communication board, the second support member having an electrical conductivity higher than an electrical conductivity of the first support member and configured to support the wireless communication board, a signal processing board configured to process the signal received by the wireless communication board, an accommodating member configured to accommodate the signal processing board, and a frame member made of metal and configured to constitute part of a casing of the image forming apparatus. The first support member is configured to be supported by the accommodating member and the second support member is configured to be supported by the frame member.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an image forming apparatus of the present embodiment.

FIG. 2 is a schematic diagram illustrating a configuration of the image forming apparatus.

FIG. 3 is a rear view schematically illustrating arrangement of electrical boards.

FIG. 4 is a control block diagram illustrating a control system of a main control board.

FIG. 5 is a perspective view illustrating a casing of the image forming apparatus.

FIG. 6 is a perspective view illustrating the casing of the image forming apparatus, on which the electrical boards are disposed.

FIG. 7 is an exploded perspective view illustrating a wireless LAN unit.

FIG. 8 is an enlarged view illustrating a ground-plate and a ground-plate holding portion.

FIG. 9 is an enlarged view illustrating a ground spring.

FIG. 10 is a diagram illustrating a method for attaching the wireless LAN unit.

FIG. 11 is a perspective view illustrating the wireless LAN unit after attachment.

### DESCRIPTION OF THE EMBODIMENTS

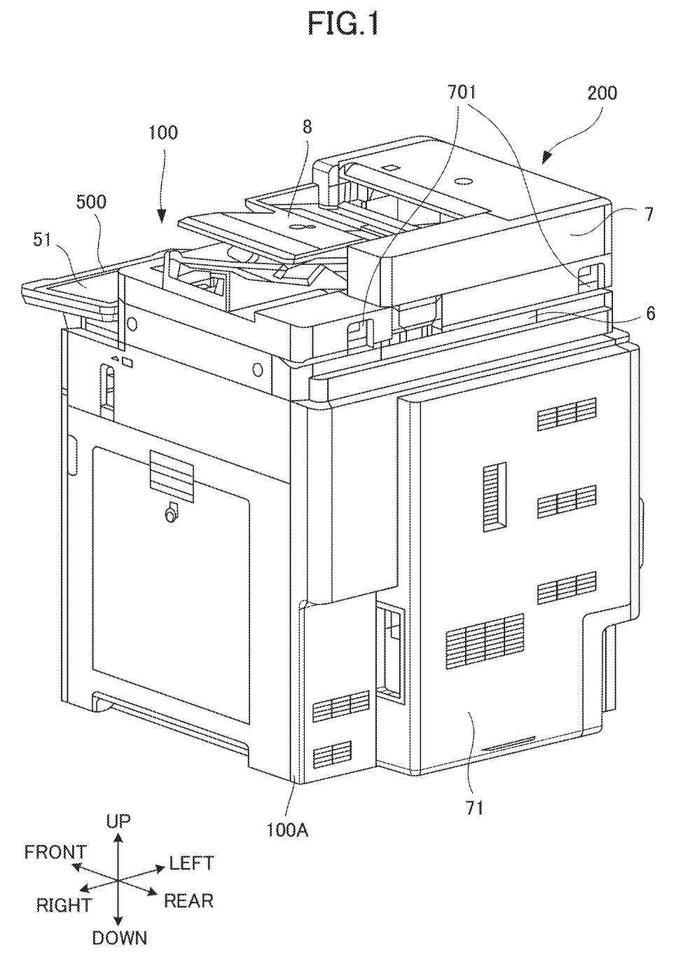

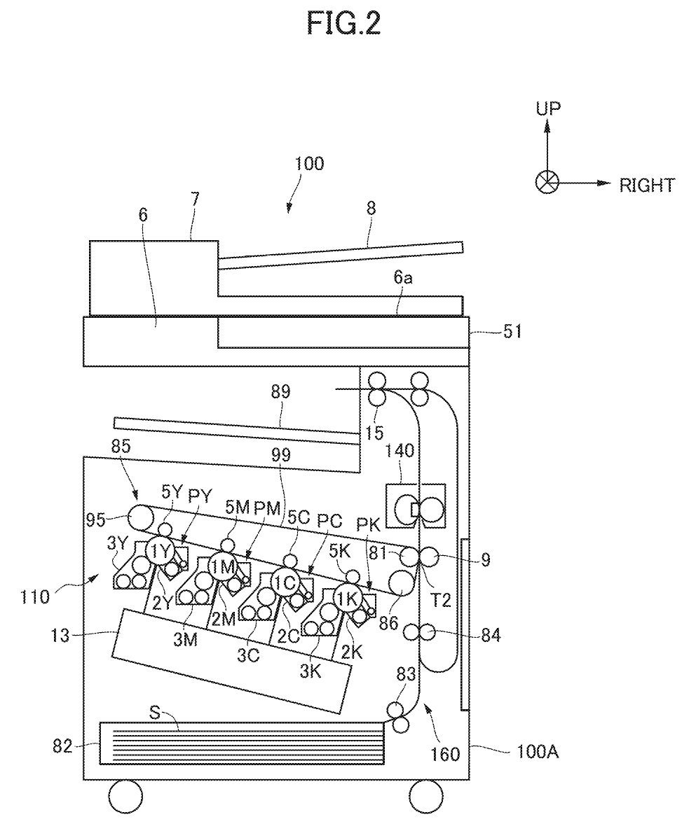

Hereinafter, the present embodiment will be described with reference to drawings. First, an image forming apparatus of the present embodiment will be described with reference to FIGS. 1 and 2. In the present embodiment, an internal-discharge-type image forming apparatus 100 will be described as an example.

As illustrated in FIG. 1, the image forming apparatus 100 includes an apparatus body 100A and a document reading apparatus 200 disposed on the apparatus body 100A. The image forming apparatus 100 forms a toner image on a recording material, based on image data sent from the document reading apparatus 200 or an external apparatus (not shown), such as a personal computer or a portable terminal. Note that on the rear side of the apparatus body 100A, a rear cover 71 that constitutes part of the exterior of the apparatus body 100A is detachably disposed.

The document reading apparatus 200 includes an image reading portion 6 that reads an image of a document, and an automatic document feeder 7. The image reading portion 6 is a flatbed scanner, and optically reads an image of a document placed on a reading surface 6a (see FIG. 2) constituted by a glass plate. The automatic document feeder 7 automatically conveys a document stacked on a document tray 8, and causes an optical sensor (not shown) to read an image of the document. The automatic document feeder 7 is supported so as to be able to pivot around a hinge portion 701 in an up-down direction. The reading surface 6a of the image reading portion 6 is exposed to the outside in a case where the automatic document feeder 7 is opened upward. Thus, a user can cause the image reading portion 6 to read an image of a document, by placing the document on the reading surface 6a exposed to the outside by opening the automatic document feeder 7.

In addition, in the apparatus body 100A, an operation-and-display portion 51 is disposed on a front side. The operation-and-display portion 51 includes a display portion that can display various types of information; and keys and switches that can input various types of information, depending on a user operation. The operation-and-display portion 51 includes an NFC (near field communication) communication portion 500 for communicating with an external portable terminal (e.g., a smartphone or an IC card) by using the Near Field Communication. The NFC communication portion 500 includes an NFC board, and if a user holds a portable terminal over the NFC board, the NFC communication portion 500 allows the wireless communication between the portable terminal and the image forming apparatus 100.

Note that in the present specification, a side on which a user stands for operating the operation-and-display portion 51 for operating the image forming apparatus 100 is referred to as a front side (front), and a side opposite to the front side (front) is referred to as a rear side (rear). In addition, a left side of the image forming apparatus 100 viewed from the front side is referred to as left, and a right side of the image forming apparatus 100 viewed from the front side is referred to as right.

As illustrated in FIG. 2, the apparatus body 100A includes a conveyance portion 160 that conveys a recording material S in the apparatus body 100A, an image forming portion 110 that forms an image by transferring a toner image to the recording material S, and a fixing portion 140 that fixes the toner image to the recording material S. The conveyance portion 160 includes a plurality of conveyance rollers, such as feeding rollers 83, registration rollers 84, and discharging rollers 15, that rotate and convey the recording material S.

The image forming portion 110 includes process cartridges P (PY, PM, PC, and PK), primary transfer rollers 5 (5Y, 5M, 5C, and 5K), a laser scanner unit 13, and an intermediate transfer unit 85. The process cartridges P include photosensitive drums 1 (1Y, 1M, 1C, and 1K), charging rollers 2 (2Y, 2M, 2C, and 2K) that charge the surfaces of the photosensitive drums 1, and development units 3 (3Y, 3M, 3C, and 3K).

The intermediate transfer unit 85 includes an intermediate transfer belt 99, a secondary transfer outer roller 9, a secondary transfer inner roller 81, an idler roller 86, a tension roller 95, and the like. The intermediate transfer belt 99 is an endless belt stretched by and wound around the secondary transfer inner roller 81, the idler roller 86, and the tension roller 95, and is rotated by the rotation of the secondary transfer inner roller 81 serving also as a driving roller and rotated by a driving motor (not shown).

Next, an image forming operation will be described. The feeding rollers 83 and the registration rollers 84 convey the recording material S stacked on and stored in a sheet stacking portion 82, to a secondary transfer portion T2. The secondary transfer portion T2 is a nip portion which is formed by the secondary transfer outer roller 9 and the secondary transfer inner roller 81 that face each other via the intermediate transfer belt 99, and in which a toner image is transferred from the intermediate transfer belt 99 to the recording material S by the application of predetermined pressing force and secondary transfer bias.

The charging roller 2 uniformly charges the surface of the photosensitive drum 1. The laser scanner unit 13 emits a laser beam to the charged photosensitive drum 1 in accordance with image data sent from the document reading apparatus 200 or an external apparatus (not shown), and thereby forms an electrostatic latent image on the photosensitive drum 1. The development unit 3 develops the electrostatic latent image formed on the photosensitive drum 1, by using toner having a corresponding color. The toner image formed on the photosensitive drum 1 in this manner is primary-transferred from the photosensitive drum 1 to the intermediate transfer belt 99 by a primary transfer bias being applied to the primary transfer roller 5.

The toner image primary-transferred to the intermediate transfer belt 99 is sent to the secondary transfer portion T2 by the rotation of the intermediate transfer belt 99. In the secondary transfer portion T2, the toner image is secondary-transferred from the intermediate transfer belt 99 to the recording material S by a secondary transfer bias being applied to the secondary transfer inner roller 81. The recording material S to which the toner image has been transferred is heated and pressed in the fixing portion 140, so that the toner image is fixed to the recording material S. The recording material S to which the toner image has been fixed is discharged to a discharging portion 89 by the discharging rollers 15.

### Electrical Board

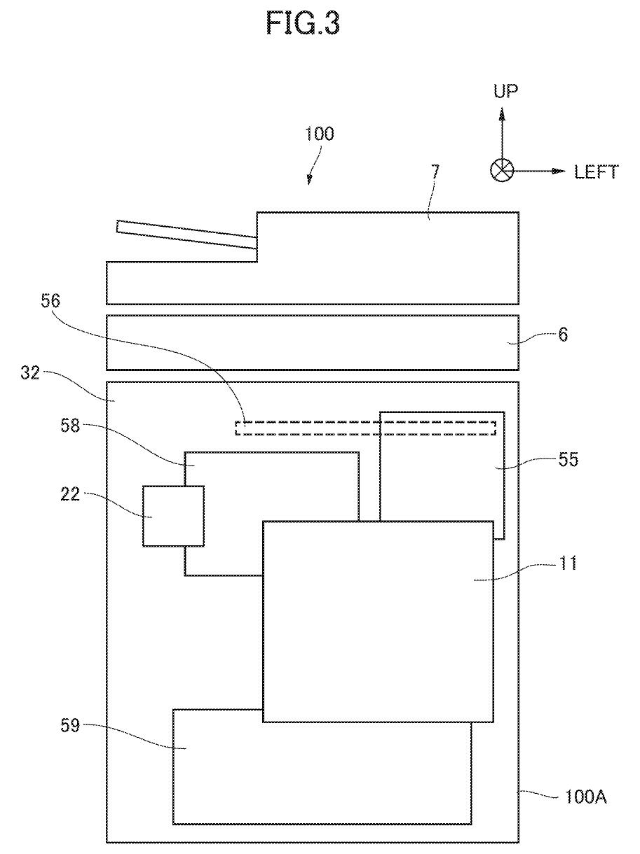

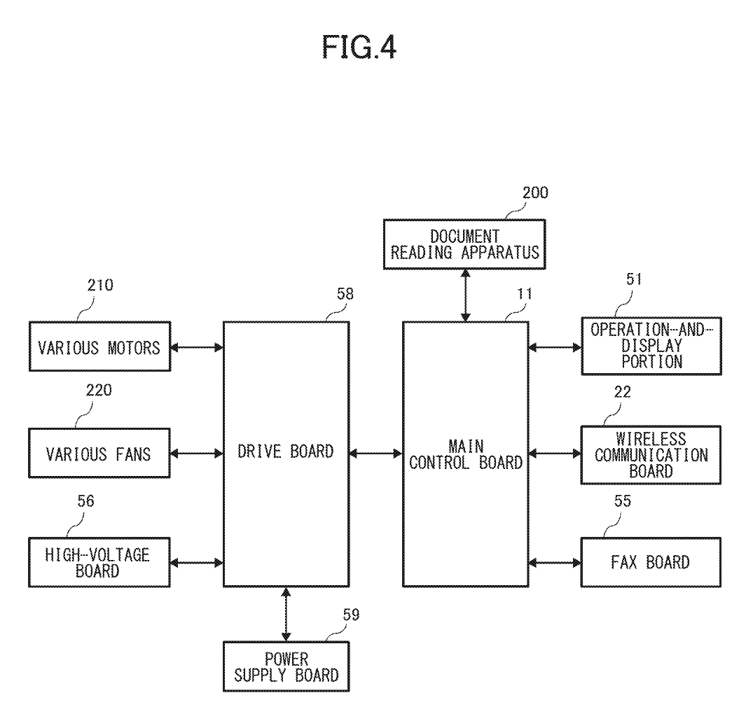

In the image forming apparatus 100, various electrical boards are disposed. On each electrical board, one or more electric components including a CPU, memories, resistors, capacitors, and connectors are mounted on a mounting surface. The electrical boards will be described with reference to FIGS. 3 and 4. FIG. 3 is a rear view schematically illustrating arrangement of the electrical boards. FIG. 4 is a control block diagram illustrating a control system of a main control board. Note that although a main control board 11 and a drive board 58 illustrated in FIG. 4 are each connected with various components other than those illustrated in FIG. 4, the illustration and description thereof will be omitted.

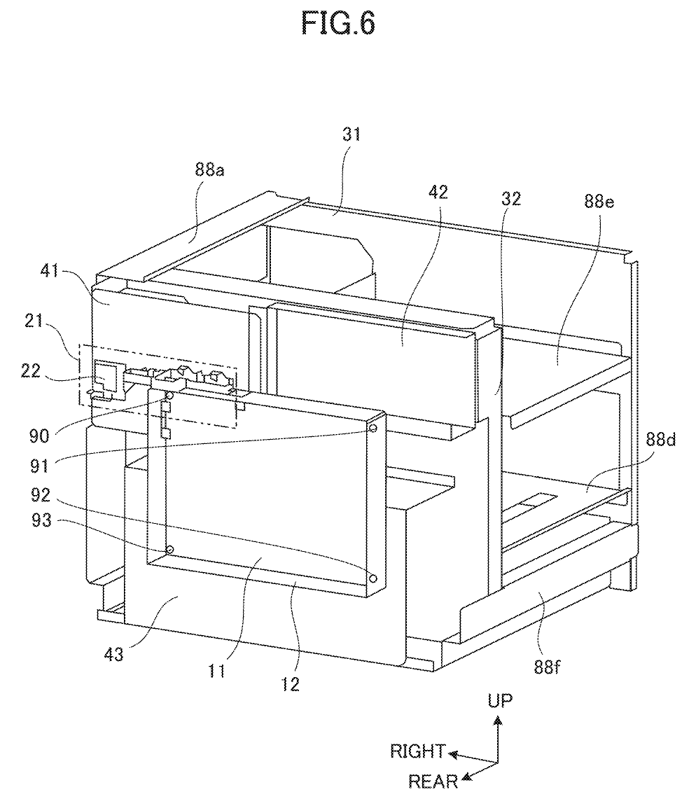

As illustrated in FIG. 3, on the rear side of the apparatus body 100A, the main control board 11, a wireless communication board 22, a FAX board 55, a power supply board 59, and the drive board 58 are disposed such that a mounting surface of each of the boards faces in the front-rear direction. These electrical boards are disposed so as to partially overlap with each other in the front-rear direction when viewed from the rear side of the image forming apparatus 100. In the apparatus body 100A, a high-voltage board 56 is disposed such that a mounting surface thereof faces in the up-down direction. As described below, the wireless communication board 22 is disposed in a wireless LAN unit 21, and the main control board 11 is accommodated in a main-control-board holding case 12 that serves as an accommodating member. In addition, the drive board 58 is supported by a support plate 41, the FAX board 55 is supported by a support plate 42, and the power supply board 59 is supported by a support plate 43 (see FIG. 6).

The main control board 11 controls the operation of the whole of the image forming apparatus 100, and causes the image forming apparatus 100 to form an image on the recording material S, based on image data sent from the document reading apparatus 200 or a portable terminal. For example, as illustrated in FIG. 4, the main control board 11 is connected with the document reading apparatus 200 and the operation-and-display portion 51; and performs reading control for the document reading apparatus 200 to read a document, and display control for the operation-and-display portion 51 to display various types of information and input control for the operation-and-display portion 51 to input various types of information. In addition, the main control board 11 is connected with the wireless communication board 22 and the FAX board 55; and performs data acquisition control for the wireless communication board 22 to acquire data from a portable terminal via wireless communication, and data acquisition control for the FAX board 55 to acquire data from an external apparatus via FAX communication. The wireless communication board 22 controls wireless connection with a portable terminal, and the FAX board 55 controls FAX communication with an external apparatus. The main control board 11 that serves as a signal processing board can process signals received by the wireless communication board 22 and the FAX board 55.

Furthermore, the main control board 11 is connected with the drive board 58. For example, the drive board 58 is connected with various motors 210 that drive the photosensitive drum 1, the secondary transfer inner roller 81, and the like, and with various fans 220 including an intake fan that takes in the air from the outside of the apparatus body 100A and a discharge fan that discharges the air from the inside to the outside of the apparatus body 100A. The drive board 58 controls the operation of the various motors 210 and various fans 220 under the control of the main control board 11. In addition, the drive board 58 is connected with the power supply board 59 and the high-voltage board 56. The power supply board 59 performs distribution of alternating-current electric power supplied from a commercial power source, and power supply control such as conversion from alternating-current electric power to direct-current electric power. The high-voltage board 56 performs application control of the primary transfer bias to the primary transfer roller 5, and application control of the secondary transfer bias to the secondary transfer inner roller 81, based on the electric power supplied from the power supply board 59, under the control of the main control board 11. By the high-voltage board 56 performing the application control, the primary transfer bias whose polarity is opposite to the toner charging polarity is applied to the primary transfer roller 5, and the secondary transfer bias whose polarity is the same as the toner charging polarity is applied to the secondary transfer inner roller 81.

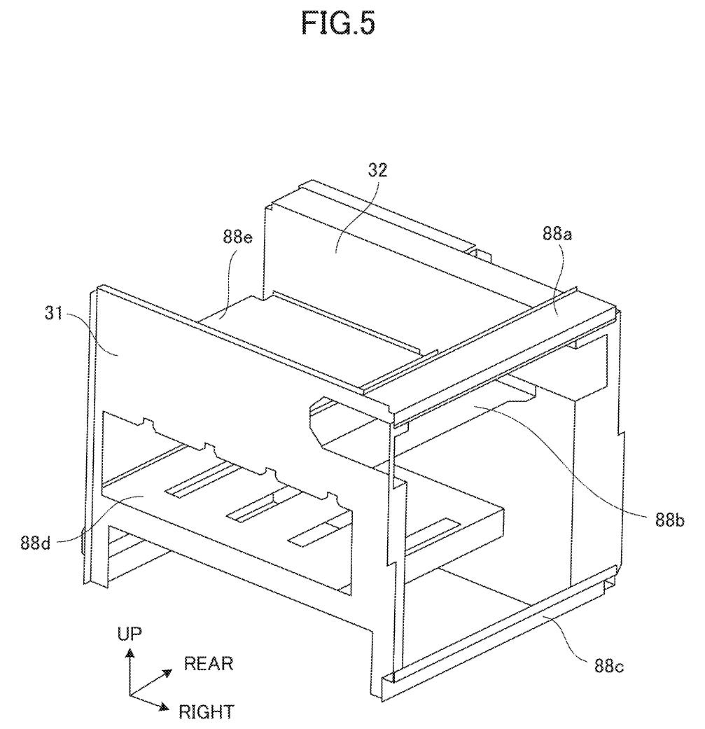

Next, the arrangement of the above-described electrical boards of the image forming apparatus 100 will be described with reference to FIGS. 5 and 6 while referring to FIGS. 2 and 3. FIG. 5 is a perspective view illustrating a casing of the image forming apparatus 100. FIG. 6 is a perspective view illustrating the casing of the image forming apparatus 100 in which the electrical boards are disposed.

### Configuration of Casing

As illustrated in FIGS. 5 and 6, the image forming apparatus 100 includes a front plate 31 disposed on the front side of the apparatus body 100A, a rear plate 32 disposed on the rear side of the apparatus body 100A, and stays 88 (88a, 88b, 88c, 88d, 88e, and 88f). The front plate 31, the rear plate 32, and the stays 88 are made of metal, and linked with each other by welding, screw fastening, or the like. In the front plate 31, a fitting hole is formed. The four process cartridges P (PY, PM, PC, and PK) can be fit in and supported by the fitting hole. The rear plate 32 is disposed so as to face the front plate 31. As illustrated in FIG. 6, the rear plate 32 is attached with the metal support plates 41, 42, and 43 by welding, screws, or the like. The support plate 41 supports the drive board 58, the support plate 42 supports the FAX board 55, and the support plate 43 supports the power supply board 59.

The stays 88 (88a to 88f) link the front plate 31 and the rear plate 32 disposed in the front-rear direction. Each of the above-described front plate 31, rear plate 32, and support plates 41, 42, and 43, in addition to the stays 88, is a frame member that is made of metal and that constitutes part of the casing of the image forming apparatus 100. The stay 88a is disposed at the upper right of the casing, the stay 88c is disposed at the lower right of the casing, and the stay 88f is disposed on the left of the casing. Each of the stays 88a, 88c, and 88f is a beam member (beam) that links components of the casing and reinforces the casing. The stay 88b is a reinforcing support plate that supports the fixing portion 140 and reinforces the casing. The stay 88d is a reinforcing support plate that supports the laser scanner unit 13 and reinforces the casing. The stay 88e is a reinforcing support plate that supports the high-voltage board 56 and reinforces the casing.

As illustrated in FIG. 6, the main control board 11 is attached to the main-control-board holding case 12 via a plurality of screws 90, 91, 92, and 93. The main-control-board holding case 12 is a case made of metal, and protects the main control board 11 from electrical noise such as static electricity and electromagnetic wave, by covering the whole of the main control board 11. In the present embodiment, an upper right portion of the main-control-board holding case 12 is attached to the support plate 42, and a lower right portion and a lower left portion of the main-control-board holding case 12 are attached to the support plate 43 via linking plates and screws (not shown). Note that in the present embodiment, the main-control-board holding case 12 is in contact with the support plates 42 and 43, but is not in contact with the support plate 41.

### Wireless LAN Unit

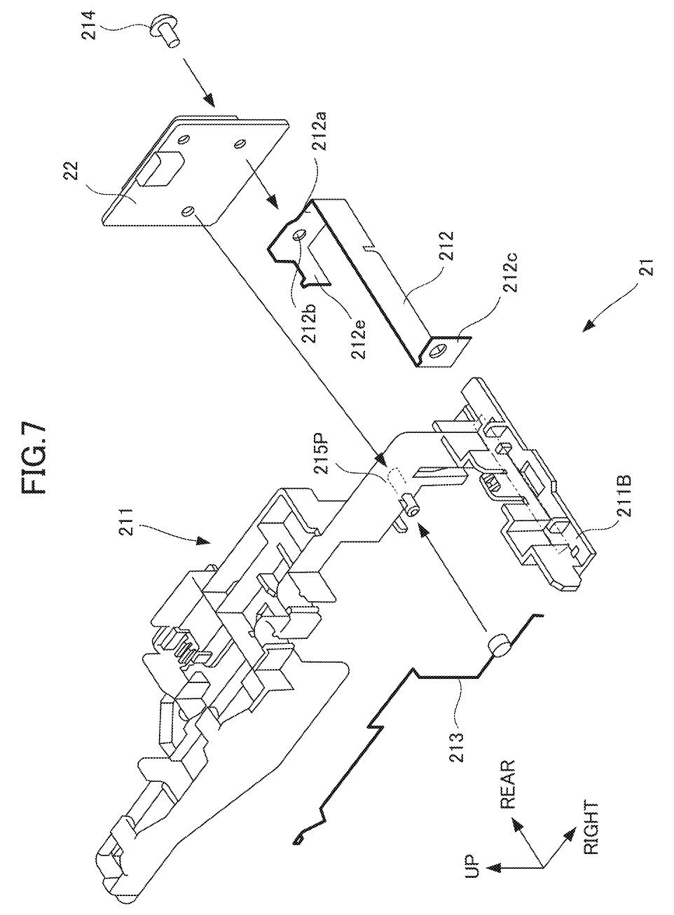

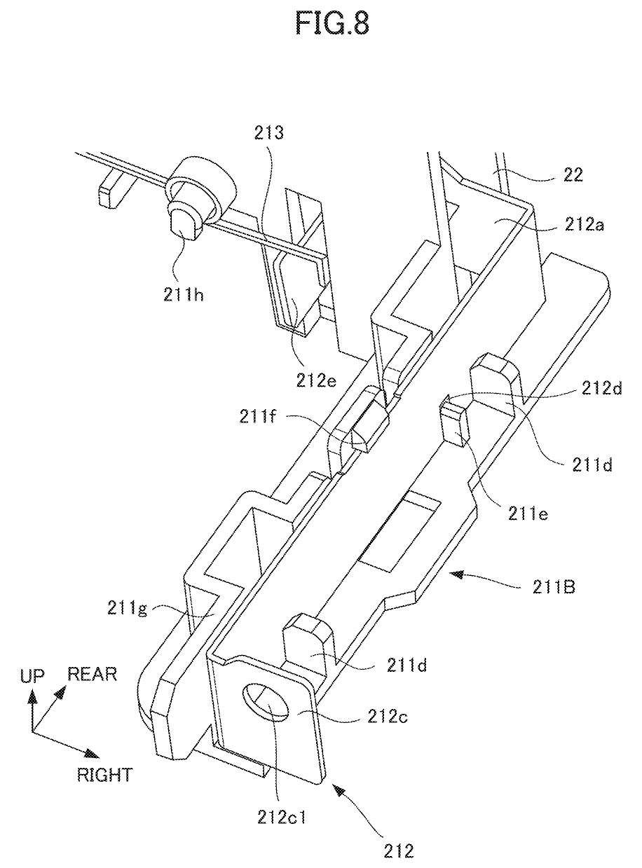

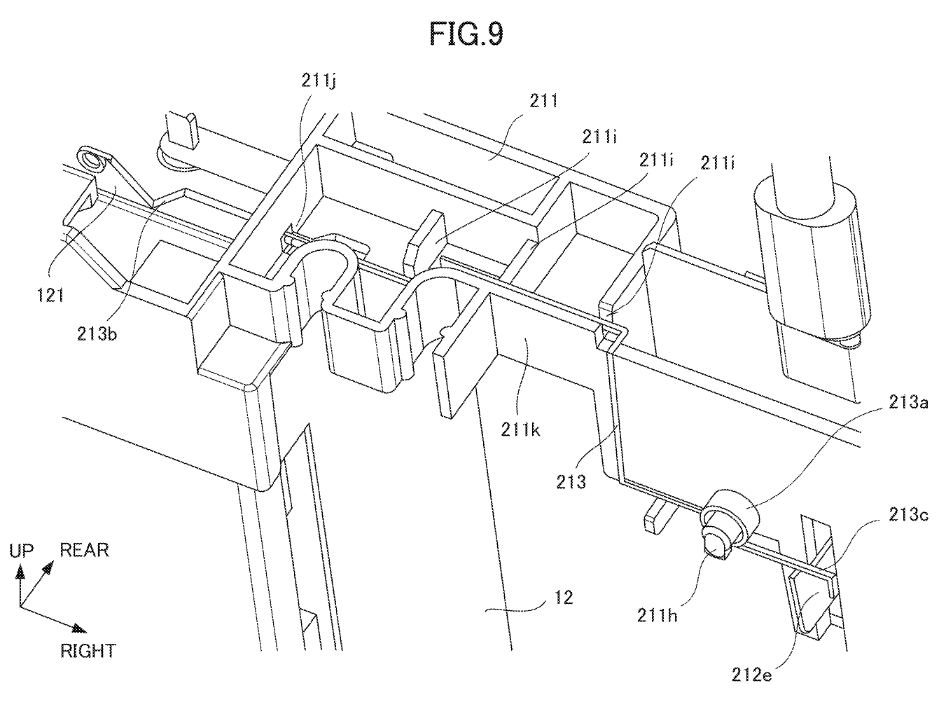

Next, the wireless LAN unit 21 in which the above-described wireless communication board 22 is disposed will be described with reference to FIGS. 6 - 9. FIG. 7 is an exploded perspective view illustrating the wireless LAN unit. FIG. 8 is an enlarged view illustrating a ground-plate and a ground-plate holding portion. FIG. 9 is an enlarged view illustrating a ground spring.

The wireless LAN unit 21 is a unit for performing the Wi-Fi communication whose communication range is wider than that of the above-described NFC communication portion 500. That is, the communication range of the NFC communication portion 500 is about 100 mm, whereas the communication range of the wireless LAN unit 21 (specifically the wireless communication board 22) is about 100 m. In the present embodiment, the NFC communication portion 500 whose communication range is narrow is disposed on the front side, and the wireless LAN unit 21 whose communication range is wide is disposed on the rear side, as indicated by a dot-dot-dash line in FIG. 6. The wireless LAN unit 21 can receive a signal, such as image data, related to image formation and sent from an external apparatus (not shown), such as a personal computer or a portable terminal, via wireless communication. In addition, the wireless LAN unit 21 can send image data read by the document reading apparatus 200, to the external apparatus.

As illustrated in FIG. 7, the wireless LAN unit 21 includes the wireless communication board 22 that sends and receives signals via wireless communication, a wireless-communication-board holder 211 that serves as a first support member, and a ground-plate 212 that serves as a second support member and that has an electrical conductivity higher than that of the wireless-communication-board holder 211. In the present embodiment, the wireless communication board 22 is supported by the wireless-communication-board holder 211 and the ground-plate 212. The wireless-communication-board holder 211 is supported by the main-control-board holding case 12. Note that a material having a higher electrical conductivity has a lower specific resistance.

The ground-plate 212 is a member made of metal and used for supporting and grounding the wireless communication board 22. In the ground-plate 212, a board attachment portion 212a is formed for attaching the wireless communication board 22 to the ground-plate 212. For example, the board attachment portion 212a is formed by bending one end portion of a long metal plate to the left. In the board attachment portion 212a, a fastening hole 212b is formed for a screw 214 to be fastened therein. Thus, the wireless communication board 22 is fixed to the board attachment portion 212a of the ground-plate 212 via the screw 214. In addition, in the ground-plate 212, a tip of the board attachment portion 212a is folded back to form a hook portion 212e for making contact with the metal ground spring 213 for electrical connection. In addition, the other end portion of the ground-plate 212, which is opposite to the board attachment portion 212a, is bent to the right opposite to the one end portion, to form a fixing portion 212c for fixing the ground-plate 212 to the support plate 41. The ground-plate 212 is fixed to the support plate 41, so that the ground of the wireless communication board 22 is ensured.

The wireless-communication-board holder 211 is made of resin, and includes a positioning boss 215P for preventing the rotation of the wireless communication board 22 fixed to the ground-plate 212 via the screw 214. In addition, the wireless-communication-board holder 211 includes a holding portion 211B that holds the ground-plate 212. As illustrated in FIG. 8, the holding portion 211B includes guide ribs 211d formed at two positions separated from each other in the front-rear direction, a restricting rib 211e formed between the guide ribs 211d positioned at the two positions in the front-rear direction, a wall portion 211g that faces the guide ribs 211d in the left-right direction, and a locking hook 211f formed on the wall portion 211g so as to be able to elastically deform.

The ground-plate 212 is held between the guide ribs 211d and the wall portion 211g, which faces the guide ribs 211d. In a state where the ground-plate 212 is held between the guide ribs 211d and the wall portion 211g, the restricting rib 211e fits in a fitting portion 212d formed in the ground-plate 212, and the locking hook 211f locks from above, an edge portion of the ground-plate 212 formed in the lateral direction of the ground-plate 212. Thus, the ground-plate 212 is held by the holding portion 211B in a state where the ground-plate 212 is restricted from moving in the left-right direction by the guide ribs 211d and the wall portion 211g, in the front-rear direction by the restricting rib 211e, and in the up-down direction by the locking hook 211f.

Furthermore, the wireless LAN unit 21 includes the ground spring 213. The ground spring 213 that has elasticity is a linear member made of metal (metal member) and used for grounding the main-control-board holding case 12 via the ground-plate 212, and is held by the wireless-communication-board holder 211. As illustrated in FIG. 9, the ground spring 213 includes a first contact portion 213b and a second contact portion 213c. In a state where the wireless-communication-board holder 211 is supported by the main-control-board holding case 12, the first contact portion 213b is in contact with the main-control-board holding case 12, and the second contact portion 213c is in contact with the ground-plate 212. In this manner, the ground spring 213 electrically connects the main-control-board holding case 12 and the ground-plate 212.

In the wireless-communication-board holder 211, a projection portion 211h which has a separation prevention portion is formed for holding the ground spring 213. The ground spring 213 includes a coil portion 213a formed like a ring, and is held by the projection portion 211h which has a separation prevention portion and which extends through the coil portion 213a. In a state where the coil portion 213a is disposed such that the projection portion 211h which has a separation prevention portion extends through the coil portion 213a, the second contact portion 213c is hooked by the hook portion 212e of the ground-plate 212, so that the ground spring 213 and the ground-plate 212 contact each other. In this manner, the ground of the main-control-board holding case 12 to the support plate 41 is ensured.

In addition, in the wireless-communication-board holder 211, restricting ribs 211i and a restricting hole 211j are formed. The plurality of restricting ribs 211i is disposed along the longitudinal direction (i.e., the left-right direction), and together with a front wall portion 211k of the wireless-communication-board holder 211, holds the ground spring 213 therebetween in a state where the coil portion 213a is disposed such that the projection portion 211h which has a separation prevention portion extends through the coil portion 213a. The ground spring 213 extends through the restricting hole 211j such that the first contact portion 213b is positioned on the left side with respect to a wall portion in which the restricting hole 211j is formed, and that the second contact portion 213c is positioned on the right side with respect to the wall portion. The restricting hole 211j restricts the ground spring 213, which is in a state where the coil portion 213a is disposed such that the projection portion 211h which has a separation prevention portion extends through the coil portion 213a, from moving upward. As a result, the first contact portion 213b is abutted against a top surface 121 of the main-control-board holding case 12, so that the ground spring 213 and the main-control-board holding case 12 are continuously in contact with each other. Note that as illustrated in FIG. 9, the first contact portion 213b of the ground spring 213 is preferably bent toward the top surface 121 of the main-control-board holding case 12 because the ground spring 213 and the main-control-board holding case 12 can be more reliably in contact with each other.

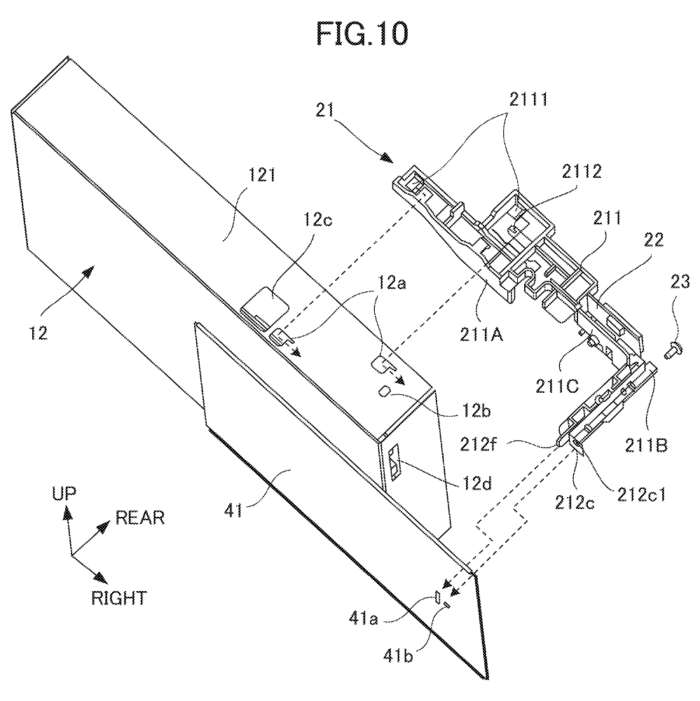

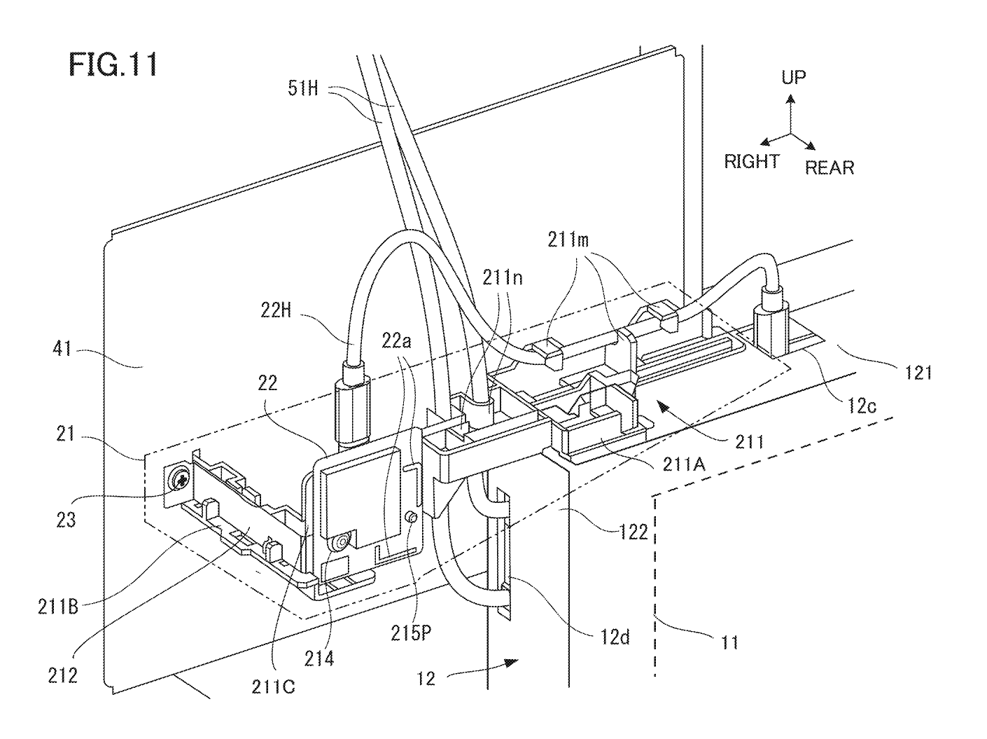

Next, a method of attaching the wireless LAN unit 21 will be described with reference to FIGS. 10 and 11 while referring to FIGS. 7 and 8. FIG. 10 is a diagram illustrating the method for attaching the wireless LAN unit 21. FIG. 11 is a perspective view illustrating the wireless LAN unit 21 after attachment.

As illustrated in FIG. 10, the wireless LAN unit 21 is attached to the image forming apparatus 100 by the wireless-communication-board holder 211 being supported by the main-control-board holding case 12, and by the ground-plate 212 being supported by the support plate 41. The wireless-communication-board holder 211 includes a supported portion 211A that is supported by the main-control-board holding case 12; the holding portion 211B that holds the ground-plate 212; and a connecting portion 211C that is continuous with the supported portion 211A and the holding portion 211B, and that connects the supported portion 211A and the holding portion 211B. The wireless communication board 22 is supported by the connecting portion 211C. In the connecting portion 211C, the above-described positioning boss 215P (see FIG. 7) is formed for preventing the rotation of the wireless communication board 22.

The wireless-communication-board holder 211 is supported by the main-control-board holding case 12. For achieving this, locking holes 12a that serve as a locked portion are formed in the top surface 121 of the main-control-board holding case 12 at a plurality of positions (two positions in the present embodiment). On the other hand, locking portions 2111 that project downward from the bottom surface of the supported portion 211A are formed on the wireless-communication-board holder 211 at a plurality of positions (two positions in the present embodiment). The locking portions 2111 are locked to the locking holes 12a, so that the supported portion 211A is restricted from moving in the up-down direction and the front-rear direction. Note that one locking portion 2111 may be formed and locked to one locking hole 12a. In addition, in the top surface 121 of the main-control-board holding case 12, a long hole 12b elongated in the front-rear direction is formed; and on the wireless-communication-board holder 211, a position-restricting insertion portion 2112 that projects downward from the bottom surface of the supported portion 211A is formed. The position-restricting insertion portion 2112 is inserted into the long hole 12b, so that the supported portion 211A is restricted from moving in the left-right direction. In this manner, the wireless-communication-board holder 211 is supported by the main-control-board holding case 12 in a state where the wireless-communication-board holder 211 is restricted from moving. Note that in a state where the locking portions 2111 are locked to the locking holes 12a, the first contact portion 213b of the ground spring 213 is in contact with the top surface 121 of the main-control-board holding case 12, as described above (see FIG. 9).

The ground-plate 212 is supported by the support plate 41. The ground-plate 212 is fixed to the support plate 41 via a screw 23. For achieving this, a fastening hole 41b for fastening the screw 23 is formed in the support plate 41, and a through-hole 212c1 which the shaft portion of the screw 23 can pass through is formed in the fixing portion 212c of the ground-plate 212. In addition, for ease of fastening with the screw 23, the through-hole 212c1 and the fastening hole 41b are substantially aligned with each other, an insertion portion 212f is formed at an end of the holding portion 211B of the wireless-communication-board holder 211, and a fitting hole 41a into which the insertion portion 212f can fit is formed in the support plate 41. That is, the insertion portion 212f is fit in the fitting hole 41a, so that the wireless LAN unit 21 is positioned with respect to the support plate 41 at a position at which the position of the through-hole 212c1 and the position of the fastening hole 41b substantially match each other.

As illustrated in FIG. 11, the wireless communication board 22 includes one or more antennas 22a (two antennas in the illustrated example) used for wireless communication. In a case where a metal member is disposed in the vicinity of the antennas 22a, as the area of the metal member increases, the metal member may more likely affect the transmission and reception of radio waves of the antennas 22a. For this reason, it is preferable that the metal member be not disposed in the vicinity of the antennas 22a. Thus, in the present embodiment, the connecting portion 211C that supports the wireless communication board 22 is disposed at a position at which the connecting portion 211C does not overlap with the main-control-board holding case 12 when the wireless LAN unit 21 is viewed from a direction (the front-rear direction in the present embodiment) orthogonal to the mounting surface of the main control board 11 accommodated in the main-control-board holding case 12. That is, the wireless communication board 22 that includes the antennas 22a is disposed at a position separated from the main-control-board holding case 12 that has an area larger than that of the screw 214 and the ground-plate 212. Thus, the wireless communication board 22 can perform excellent transmission and reception of signals, without the transmission and reception of radio waves of the antennas 22a being affected.

In addition, the wireless communication board 22 is electrically and communicatively connected with the main control board 11 accommodated in the main-control-board holding case 12, via a cable 22H. A connector portion of the main control board 11 to which one end of the cable 22H is connected is exposed to the outside through an opening portion 12c formed in the top surface 121 of the main-control-board holding case 12. In the supported portion 211A of the wireless-communication-board holder 211, a plurality of guide portions 211m is disposed for guiding the cable 22H between the main control board 11 and the wireless communication board 22. The cable 22H whose one end is connected to the connector portion of the main control board 11 is guided to the wireless communication board 22 by the guide portions 211m, and the other end of the cable 22H is connected to a connector portion of the wireless communication board 22. Note that one guide portion 211m may be disposed.

Note that in the supported portion 211A of the wireless-communication-board holder 211, guide portions 211n may be disposed for guiding another cable other than the above-described cable 22H. For example, the guide portions 211n guide cables 51H that electrically and communicatively connects the operation-and-display portion 51 (see FIG. 1) and the main control board 11. Connector portions of the main control board 11 to which one ends of the cables 51H are respectively connected are exposed to the outside through an opening portion 12d formed in a side surface 122 of the main-control-board holding case 12. The cables 51H whose one ends are connected to connector portions of the operation-and-display portion 51 are guided to the main control board 11 by the guide portions 211n, and the other ends of the cables 51H are connected to the connector portions of the main control board 11. Note that although the description has been made, in the present embodiment, for an example where the cables 51H, which connect the operation-and-display portion 51 and the main control board 11, are guided, the present disclosure is not limited to this.

As described above, in the present embodiment, the wireless LAN unit 21 that includes the wireless communication board 22, the wireless-communication-board holder 211, and the ground-plate 212 having an electrical conductivity higher than that of the wireless-communication-board holder 211 is attached to the image forming apparatus 100. The wireless LAN unit 21 is attached to the image forming apparatus 100 in a state where the wireless communication board 22 is supported by the wireless-communication-board holder 211 and the ground-plate 212, where the wireless-communication-board holder 211 is fixed to the main-control-board holding case 12, and where the ground-plate 212 is fixed to the support plate 41. The ground-plate 212 is fixed to the support plate 41, so that the ground of the wireless communication board 22 is ensured. Thus, the wireless communication board 22 can be attached to the support plate 41 for ensuring the ground of the wireless communication board 22, without increasing the number of components, by using the wireless LAN unit 21. Therefore, the cost of the wireless communication board 22 attached to the image forming apparatus 100 can be reduced.

### Other Embodiments

In the above-described embodiment, the description has been made, as an example, for the intermediate-transfer image forming apparatus 100 in which toner images are primary-transferred from the photosensitive drums 1Y to 1K, which correspond to the respective colors, to the intermediate transfer belt 99, and then the toner image is secondary-transferred from the intermediate transfer belt 99 to the recording material S. However, the present disclosure is not limited to this. The above-described embodiment may be applied to a direct-transfer image forming apparatus in which toner images are directly transferred from the photosensitive drums 1Y to 1K, which correspond to the respective colors and which rotate while bearing the toner images, to the recording material S. In addition, the above-described embodiment may be applied not only to an electrophotographic image forming apparatus, but also to an image forming apparatus, such as an ink-jet system, that has another system.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-080454, filed May 13, 2025, which is hereby incorporated by reference herein in its entirety.

What is claimed is:

1. An image forming apparatus configured to form an image on a recording material, the image forming apparatus comprising:
a wireless communication board configured to receive a signal via wireless communication;
a first support member configured to support the wireless communication board;
a second support member configured to support the wireless communication board, the second support member having an electrical conductivity higher than an electrical conductivity of the first support member;
a signal processing board configured to process the signal received by the wireless communication board;
an accommodating member configured to accommodate the signal processing board; and
a frame member made of metal and configured to constitute part of a casing of the image forming apparatus,
wherein the first support member is configured to be supported by the accommodating member and the second support member is configured to be supported by the frame member.

2. The image forming apparatus according to claim 1,
wherein the first support member is a member made of resin, and
wherein the second support member is a member made of metal.

3. The image forming apparatus according to claim 1, wherein the first support member includes
a supported portion configured to be supported by the accommodating member,
a holding portion configured to hold the second support member, and
a connecting portion configured to connect the supported portion and the holding portion, and
wherein the wireless communication board is configured to be supported by the connecting portion.

4. The image forming apparatus according to claim 3,
wherein the supported portion includes a locking portion, and
wherein the accommodating member includes a locked portion configured to be locked by the locking portion.

5. The image forming apparatus according to claim 3,
wherein the accommodating member is made of metal,
wherein the wireless communication board includes an antenna used for wireless communication, and
wherein the connecting portion is configured to support the wireless communication board at a position at which the connecting portion does not overlap with the accommodating member when viewed from a direction orthogonal to a mounting surface of the signal processing board accommodated in the accommodating member, the mounting surface being a surface on which an electric component and the antenna are mounted.

6. The image forming apparatus according to claim 3, further including a metal member disposed on the first support member, wherein the metal member includes a first contact portion in contact with the accommodating member and a second contact portion in contact with the second support member, and configured to electrically connect the accommodating member and the second support member, and
wherein each of the accommodating member and the second support member is made of metal.

7. The image forming apparatus according to claim 3, further including a cable configured to communicatively connect the wireless communication board and the signal processing board, and
wherein a guide portion configured to guide the cable between the wireless communication board and the signal processing board is disposed on the supported portion.
